(19) United States
(12) Patent Application Publication
(10) Pub. No.: US 2026/0255122 A1
(43) Pub. Date: Aug. 27, 2026

(54) EFFICIENT SPATIAL AUDIO RENDERING VIA DIFFERENTIABLE FINITE IMPULSE RESPONSE (FIR) TO INFINITE IMPULSE RESPONSE (IIR) ESTIMATION

(71) Applicant: University of Maryland, College Park, College Park, MD (US)

(72) Inventors: Armin Gerami, College Park, MD (US); Ramani Duraiswami, Highland, MD (US); Julian Alexander LAGATTUTA, New Canaan, CT (US)

(21) Appl. No.: 19/549,845

(22) Filed: Feb. 25, 2026

Related U.S. Application Data
(60) Provisional application No. 63/762,854, filed on Feb. 25, 2025.

(51) Int. Cl. H04S 7/00

(52) U.S. Cl. CPC H04S 7/302; H04S 2420/01

(57) ABSTRACT

A system for converting from a finite impulse response (FIR) filter to an infinite impulse response (IIR) filter, includes: a processor and a memory, including instructions stored thereon, which when executed by the processor cause the system to: access a FIR filter representative of a physical space; access a personalized Head Related Impulse Responses (HRIRs); generate a fused FIR filter based on fusing the FIR filter and the personalized HRIR; determine an order of an IIR filter based on the fused FIR filter; generate the IIR filter based on the determined order; and optimize the generated IIR filter by performing gradient descent minimization to minimize a cost function of the generated IIR filter.

### CROSS-REFERENCE TO RELATED APPLICATION

This application claims the benefit of and priority to U.S. Provisional Patent Application No. 63/762,854, filed Feb. 25, 2025, the entire content of which (including its appendices) is incorporated by reference herein.

### GOVERNMENT SUPPORT

This invention was made with government support under N00014-23-1-2086 awarded by the Office of Naval Research. The government has certain rights in the invention.

### TECHNICAL FIELD

The subject matter of the present disclosure relates generally to spatial audio rendering. More particularly, the subject matter of the present disclosure relates to efficient spatial audio rendering by fitting/estimating finite impulse responses (FIRs) by infinite impulse responses (IRRs) to accommodate personalized head-related transfer functions (HRTFs).

### BACKGROUND

The human ability to perceive the direction of a sound source is partly the result of cues encoded in the sound reaching the eardrum after scattering off of the listener's anatomic features (torso, head, and outer ears). The frequency response of how sound is modified in phase and magnitude by such scattering is called the Head-Related Transfer Function (HRTF) and is specific to each person. Knowledge of the HRTF allows for the reconstruction of realistic auditory scenes. Various streams of spatial audio rendering research have converged into the MPEG-H standard which specifies mechanisms for rendering of up to 32 streams (a mixture of objects and ambisonics) with associated room metadata and head-tracking of the listener with respect to the source to create a dynamic spatial audio scene. Typically, the gold standard of spatial audio rendering involves convolving, via Finite Impulse Response (FIR) filtering, the streams corresponding to objects (and their early reflections off the environment) with Head Related Impulse Responses (HRIRs) that have been suitably chosen based on the user's relative motion with respect to the source via head-tracking. However, this is significantly costly in terms of computational time for convolving the generated filters and creating the tail reverberation. Furthermore, there is also a memory cost to storing the directional HRIR filters.

Accordingly, there remains a need for more efficient spatial audio rendering, that maintains audio quality while reducing computational and memory costs.

### SUMMARY

In accordance with aspects of the disclosure, a system for converting from a finite impulse response (FIR) filter to an infinite impulse response (IIR) filter, includes: a processor and a memory, including instructions stored thereon, which when executed by the processor cause the system to: access a FIR filter representative of a physical space; access a personalized Head Related Impulse Responses (HRIRs); generate a fused FIR filter based on fusing the FIR filter and the personalized HRIR; determine an order of an IIR filter based on the fused FIR filter; generate the IIR filter based on the determined order; optimize the generated IIR filter by performing gradient descent minimization to minimize a cost function of the generated IIR filter; and generate spatialized audio based on the optimized generated infinite impulse response filter.

In an aspect of the present disclosure, determining the order of the IIR filter may be performed by estimating coefficients of a time-domain representation of the IIR filter in a differentiable and convex manner.

In an aspect of the present disclosure, the order of the IIR filter may correspond to at least one of a cascade or a parallel arrangement of 4, 8, or 16 biquadratic filters.

In an aspect of the present disclosure, the instructions, when executed by the processor, may further cause the system to generate spatialized audio based on the generated IIR filter.

In an aspect of the present disclosure, the instructions, when executed by the processor, may further cause the system to dynamically change the quality of the audio by changing the number of biquadratic filters.

In an aspect of the present disclosure, the cost function may be a time domain impulse response mean squared error (MSE).

In accordance with aspects of the disclosure, a processor-implemented method for converting from a finite impulse response filter to an infinite impulse response filter includes accessing a finite impulse response filter representative of a physical space, accessing a personalized Head Related Impulse Responses (HRIR), generating a fused finite impulse response filter based on fusing the finite impulse response filter and the personalized Head Related Impulse Responses, determining an order of an infinite impulse response filter based on the fused finite impulse response filter, generating the infinite impulse response filter based on the determined order, optimizing the generated infinite impulse response filter by performing gradient descent minimization to minimize a cost function of the generated infinite impulse response filter, and generating spatialized audio based on the optimized generated infinite impulse response filter.

In accordance with aspects of the disclosure, a system for efficiently spatializing audio includes a processor and a memory storing instructions that, when executed by the processor, cause the system to generate a room impulse response composed of a set of early reflections, approximate a reverberant tail using a differentiable feedback delay network, and generate spatialized audio based on the generated set of early reflections and the generated reverberant tail.

In an aspect of the present disclosure, the set of early reflections may be generated by converting from a finite impulse response filter to an infinite impulse response filter. Converting from the finite impulse response filter to the infinite impulse response filter may include accessing a finite impulse response filter representative of a physical space, accessing a personalized HRIR, generating a fused finite impulse response filter based on fusing the finite impulse response filter and the personalized Head Related Impulse Responses, determining an order of an infinite impulse response filter based on the fused finite impulse response filter, generating the infinite impulse response filter based on the determined order, and optimizing the generated infinite impulse response filter by performing gradient descent minimization to minimize a cost function of the generated infinite impulse response filter.

In an aspect of the present disclosure, the differentiable feedback delay network may include a plurality of feedback loops. Each feedback loop may include a delay element and a feedback gain configured to generate a decaying exponential component of the reverberant tail.

In an aspect of the present disclosure, the differentiable feedback delay network may include sixteen feedback loops arranged in parallel.

In an aspect of the present disclosure, the differentiable feedback delay network may include a global decay parameter and a plurality of scale parameters and delay parameters. The global decay parameter may be constrained to a value less than one to ensure stability.

In an aspect of the present disclosure, the differentiable feedback delay network may be configured such that delay parameters are selected on a logarithmic spacing within a predefined time window corresponding to early reflection duration.

In an aspect of the present disclosure, the differentiable feedback delay network may be optimized to match at least one acoustic or psychoacoustic metric selected from the group consisting of clarity, definition, center time, and reverberation decay time.

In an aspect of the present disclosure, differentiable feedback delay network parameters may be determined by minimizing a loss function including a weighted combination of acoustic metric residuals.

In an aspect of the present disclosure, the generated set of early reflections and the generated reverberant tail may be mixed to form a synthesized room impulse response applied to an input audio stream on a sample-by-sample basis without block-based Fourier processing.

In an aspect of the present disclosure, the differentiable feedback delay network may be configured to update one or more parameters in real time in response to at least one of listener movement, source movement, or a change in room metadata.

In an aspect of the present disclosure, the optimized generated infinite impulse response filter may be implemented as a cascade arrangement of biquadratic filters or a parallel arrangement of biquadratic filters.

In an aspect of the present disclosure, converting from the finite impulse response filter to the infinite impulse response filter may include estimating coefficients of a time-domain multipath propagation model having a plurality of reflection coefficients and a shared decay coefficient.

In an aspect of the present disclosure, the fused finite impulse response filter may represent early reflections of a room impulse response. The differentiable feedback delay network may represent a reverberant tail of the room impulse response.

In an aspect of the present disclosure, the cost function minimized during gradient descent may include a time-domain mean squared error between an impulse response of the fused finite impulse response filter and an impulse response of the generated infinite impulse response filter.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a network diagram illustration showing an exemplary efficient spatial audio rendering system that decomposes a room impulse response into an early reflection component and a reverberant tail component, converts finite impulse response filters to infinite impulse response filters for efficient processing, and generates spatialized audio based on the combined outputs, in accordance with aspects of the present disclosure;

FIG. 2 is a block diagram of a controller for the system of FIG. 1 in accordance with aspects of the present disclosure;

FIG. 3 is a diagram illustrating an early reflection network implemented as a delayed sum network having a plurality of path gains and a plurality of path delays applied to a head-related impulse response.

FIG. 4 is a diagram illustrating a feedback delay network configured to generate a reverberant tail using a plurality of feedback delays and a plurality of scaling coefficients applied to an input head-related impulse response.

FIG. 5 is a diagram of a multipath propagation model using a parallel arrangement of N biquad filters, in accordance with aspects of the present disclosure.

FIG. 6 is a graph illustrating of an impulse response of FIR-to-IRR Estimation of time domain, in accordance with aspects of the present disclosure;

FIG. 7 is a graph illustrating a frequency response FIR-to-IRR Estimation, in accordance with aspects of the present disclosure;

FIG. 8 is a graph illustrating an impulse response MSE and LSD of the IRR estimation compared to the biquad filters, in accordance with aspects of the present disclosure;

FIG. 9 is a graph illustrating an example synthesized room impulse response showing a sparse early reflection portion and a decaying reverberant tail portion generated by the system of FIG. 1, in accordance with aspects of the present disclosure;

FIG. 10 is a graph illustrating an example head-related impulse response plotted over time, in accordance with aspects of the present disclosure; and

FIG. 11 is a block diagram illustrating an exemplary method for converting a finite impulse response filter to an infinite impulse response filter and generating spatialized audio, in accordance with aspects of the present disclosure.

### DETAILED DESCRIPTION

The present disclosure relates generally to spatial audio rendering by fitting/estimating finite impulse responses (FIRs) by infinite impulse responses (IRRs) to accommodate personalized head-related transfer functions (HRTFs).

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Human perception of a room's acoustics is shaped by both the early reflections and the reverberant tail. However, people are sensitive to the specific values of early reflections, while the perception of the reverberant tail relies on psychoacoustic metrics rather than individual values.

Human perception of room acoustics is influenced differently by early reflections and by the reverberant tail. Early reflections are strong and sparse in time, and listeners are sensitive to the specific timing and amplitude of those reflections because they contribute directly to spatial localization cues. In contrast, late reflections forming the reverberant tail are weaker and densely distributed in time, and perception is governed not by individual sample values but by overall room characteristics such as clarity, definition, center time, and decay time, referred to as T30. When a feedback delay network is configured so that these perceptual metrics match corresponding values of a target room, the rendered environment perceptually sounds the same even if individual late reflection samples differ.

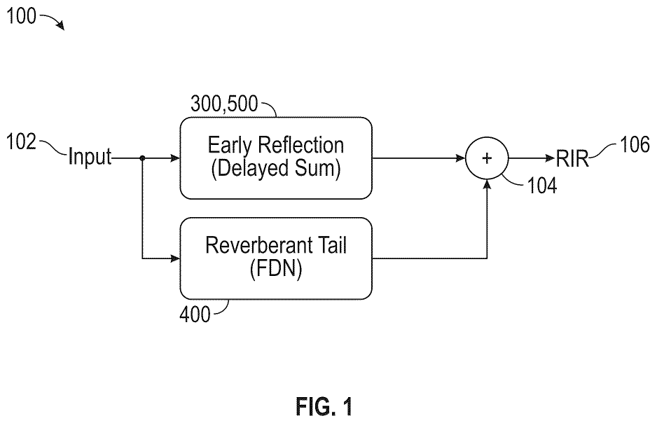

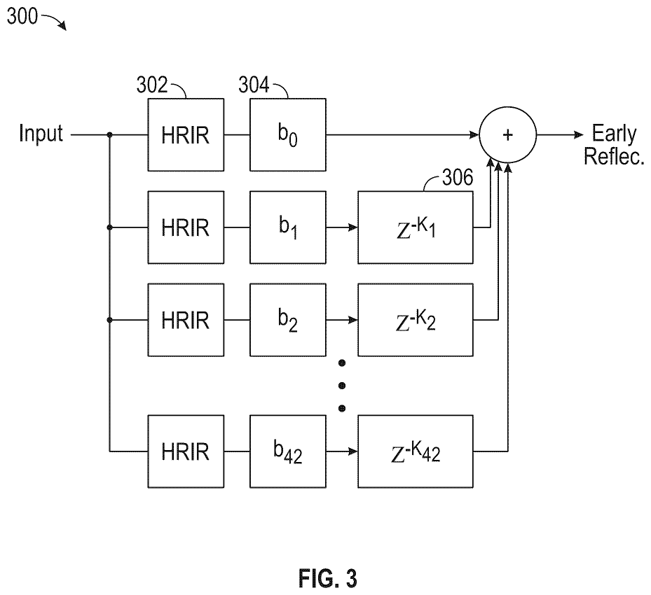

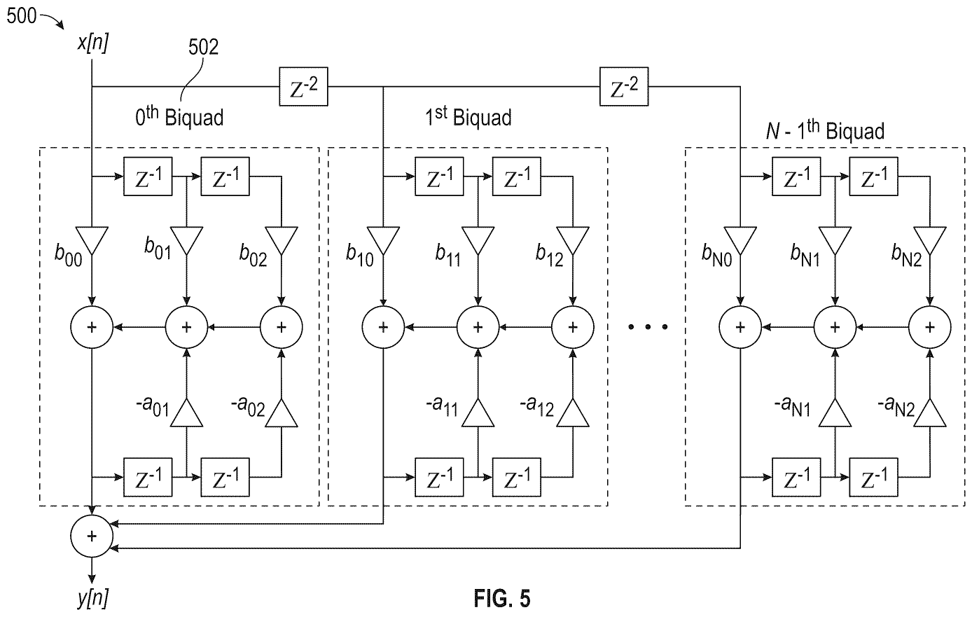

FIG. 1 illustrates a system 100 for computationally efficient and tunable feedback delay network (FDN) architecture for real-time room impulse response (RIR) rendering that addresses the computational and latency challenges inherent in traditional convolution and Fourier transform-based methods. The system 100 is configured for a two-part decomposition of the room impulse response into early reflections and a reverberant tail. The system 100 generally includes a differentiable feedback delay network (FDN) 400 for generating a reverberant tail and an early reflection network 300 configured to generate early reflections. The early reflection network 300 may be either a delayed sum network (FIG. 3) or a multipath propagation model 500 that is implemented as a collection of biquadratic filters (FIG. 5). By using the multipath propagation model 500 in combination with the FDN 400 the system provides the benefit of being computationally efficient as compared to a system that generates the reverberant tail and the early reflections using a convolutional method for both. Multipath propagation model 500 processes the early reflections by applying the prior FIR-to-IIR conversion method (FIG. 5) to each early reflection direction, effectively replacing head-related impulse responses with IIR filters and delaying them appropriately.

“Room Impulse Response Synthesis via Differentiable Feedback Delay Networks for Efficient Spatial Audio Rendering” by Armin Gerami et al., arXiv, arXiv: 2510.00238 [eess.AS], submitted Sep. 30, 2025, is hereby incorporated by reference herein in its entirety for all purposes as if fully set forth herein. “Efficient Binaural Spatial Audio Rendering Using Machine Learning Inspired Approaches,” presentation materials presented at the Joint Conference on Binaural and Spatial Hearing (BASH) 2025 on Nov. 6, 2025, by Ramani Duraiswami, is hereby incorporated by reference herein in its entirety for all purposes as if fully set forth herein.

Conventional spatial audio rendering relies on convolving input audio with long finite impulse response filters that represent a physical space and direction-dependent head-related impulse responses. Such convolution-based implementations consume significant processing resources, require large memory to store directional impulse responses, and introduce latency that degrades real-time head-tracked rendering on size, weight, and power constrained devices. The technical problem addressed is maintaining perceptually accurate spatial cues and room characteristics while reducing computing time and power, storage, and latency. The technical solution provided accesses a finite impulse response filter representative of a physical space and personalized head-related impulse responses, generates a fused finite impulse response filter that captures both environmental propagation and listener-specific filtering, determines an order for an infinite impulse response representation based on an accuracy and resource tradeoff, generates an infinite impulse response filter using that order, and optimizes coefficients through gradient descent to minimize a cost function that measures deviation from the fused finite impulse response. The optimized infinite impulse response filter is then used to generate spatialized audio through recursive filtering, enabling reduced memory footprint and lower-latency processing relative to direct finite impulse response convolution, while preserving direction-dependent localization cues and room-related perceptual characteristics.

In aspects, the system may generate early reflections using a path-based representation derived from a room impulse response and may generate the reverberant tail using the feedback delay network, such that the combination approximates a target room impulse response while reducing computational load relative to full convolution. In embodiments, the early reflections may be rendered as a delayed-sum network in which path gains and path delays are derived from a sparse set of early reflection events.

In aspects, the system may incorporate listener-specific directional filtering by associating early reflection paths with corresponding head-related impulse responses. In embodiments, the system may generate an infinite impulse response representation of a head-related impulse response so that repeated application of directional filtering across multiple objects and directions is performed using a recursive filter implementation. In such embodiments, the infinite impulse response representation may be optimized to approximate a finite impulse response target associated with a selected direction while reducing memory footprint.

In aspects, a fused finite impulse response filter may be generated for a selected direction by combining a room-related impulse response component with a direction-dependent head-related impulse response. In embodiments, the fused finite impulse response filter may be generated by convolution. In other embodiments, the fused finite impulse response filter may be generated by combining a head-related impulse response with only a selected portion of a room impulse response, such as an early reflection portion, while generating a late reverberant portion using the feedback delay network.

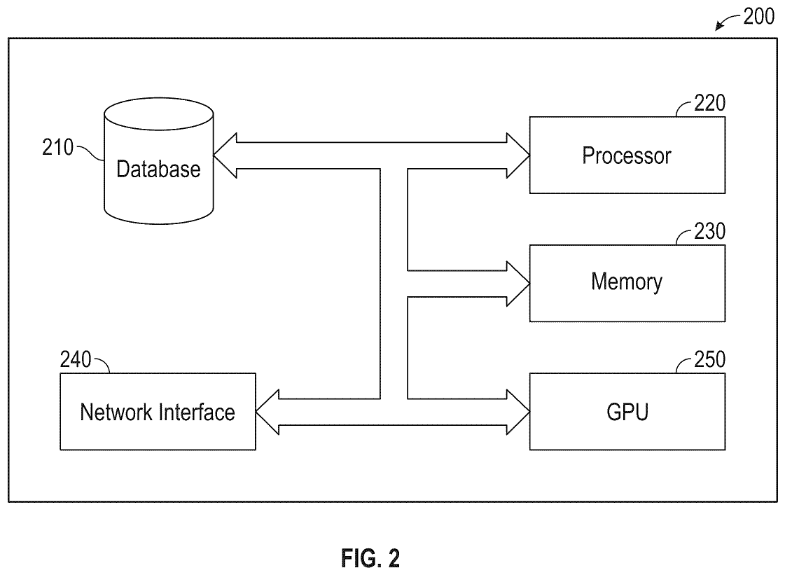

Referring now to FIG. 2, exemplary components in the controller 200 in accordance with aspects of the present disclosure include, for example, a database 210, one or more processors 220, at least one memory 230, and a network interface 240. In aspects, the controller 200 may include a graphical processing unit (GPU) 250, which may be used for processing machine learning models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

In various aspects, data may be stored on the controller 200, including, for example, user preferences, historical data, and/or other data. The data can be stored in the database 210 and sent via the system bus to the processor 220.

As will be described in more detail later herein, the processor 220 executes various processes based on instructions that can be stored in the server memory 230 and utilizing the data from the database 210. With reference also to FIG. 1, a request from a user device, such as a mobile device or a user computer, can be communicated to the server through the server's network interface 240. The illustration of FIG. 2 is exemplary, and persons skilled in the art will be understood other components that may exist in a controller 200. Such other components are not illustrated in FIG. 2 for clarity of illustration.

FIG. 3 illustrates an early reflection network 300 configured as a delayed sum network for generating early reflections of a room impulse response in an efficient spatial audio rendering system. The early reflection network 300 models direct and low-order reflections that are perceptually important for spatial localization and directional accuracy.

The early reflection network 300 receives, as an input 302, a head-related impulse response corresponding to a source direction. The head-related impulse response 302 represents body-based scattering effects associated with a listener and encodes spatial cues used for sound localization. The early reflection network 300 applies directional filtering and time delays to generate a set of discrete early reflection components corresponding to reflections from environmental surfaces.

The early reflection network 300 includes a plurality of path gain elements 304 and a plurality of path delay elements 306. Each path gain element 304 corresponds to a reflection coefficient b_i associated with a particular reflection path. Each path delay element 306 corresponds to a delay K_i representing a time-of-arrival of a corresponding reflection relative to a direct path.

Each reflection path is implemented as a delayed and scaled version of the head-related impulse response 302. For a given path i, the head-related impulse response 302 is scaled by a corresponding path gain b_i at element 304 and delayed by a corresponding path delay K_i at element 306. The outputs of the plurality of delayed and scaled paths are summed to produce a composite early reflection signal.

The early reflection network 300 thus forms a tapped delay line structure, where each tap corresponds to a distinct early reflection path. In one embodiment, the delayed sum network includes taps corresponding to a direct path, first-order reflections from room boundaries, and second-order reflections. For a room approximated as a rectangular enclosure, this may include a direct path, six first-order reflections, and thirty-six second-order reflections. The total number of paths may vary depending on room geometry and modeling requirements.

The parameters b_i of path gain elements 304 and K_i of path delay elements 306 are not determined through iterative learning in this portion of the system. Instead, these parameters are directly mapped from a target room impulse response early reflection portion. The target early reflection parameters may be obtained from acoustic measurement, computational simulation, or intentional design specifications. Because early reflections are sparse in time and perceptually sensitive to precise timing and amplitude, the direct mapping preserves spatial fidelity.

The early reflection network 300 operates in the time domain and performs sample-by-sample processing without requiring block-based convolution or Fourier transform operations. Due to the sparse nature of early reflections, the delayed sum network requires a limited number of operations relative to full convolution with a long impulse response.

The output of the early reflection network 300 may be combined with a separately generated reverberant tail to form a synthesized room impulse response. In certain embodiments, the early reflection network 300 may alternatively be implemented as a multipath propagation model realized as a collection of biquadratic filters, as illustrated in FIG. 5. However, FIG. 3 specifically illustrates an embodiment in which early reflections are generated using a delayed sum network structure.

Accordingly, the early reflection network 300 provides an efficient and physically interpretable mechanism for modeling discrete early reflections that are critical to spatial perception while maintaining low computational complexity.

In aspects, path gains and path delays may be derived from a target room impulse response by identifying an early reflection region and extracting discrete reflection events within the region. For example, the system may define the early reflection region as a time window beginning at a direct-path peak and extending to a predetermined cutoff time, and may identify reflection events within the time window using peak picking on an absolute amplitude envelope or a short-time energy envelope. Each reflection event may be mapped to a path delay that corresponds to an index of the peak relative to the direct-path peak, and may be mapped to a path gain that corresponds to a peak magnitude or an energy associated with the event.

In aspects, a set of early reflection directions may be associated with the extracted reflection events. For example, when room metadata or a simulation model is available, each reflection event may be assigned a direction based on a corresponding reflection surface and a reflection path geometry. In embodiments, when directions are not explicitly available, the system may assign early reflection directions by selecting a subset of directions from a head-related impulse response dataset and associating the directions with the largest-magnitude reflection events.

In aspects, rendering early reflections may include applying a direction-dependent head-related impulse response to each early reflection path and then applying the corresponding path delay and path gain. For example, the system may select a head-related impulse response corresponding to a direction assigned to a reflection path, generate a filtered path contribution, delay the contribution by the path delay, scale the contribution by the path gain, and sum the contributions across paths to produce an early reflection output.

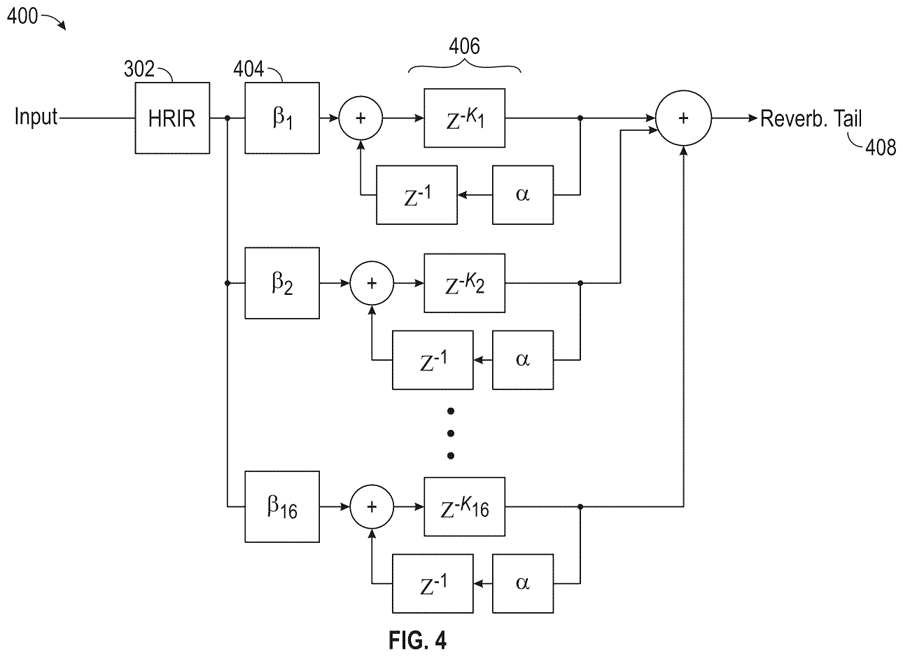

FIG. 4 illustrates a feedback delay network 400 configured to generate a reverberant tail component of a room impulse response in an efficient spatial audio rendering system. The feedback delay network 400 receives, as an input 302, a signal that has been spatially filtered by a head-related impulse response associated with a source direction. The feedback delay network 400 produces, as an output, a reverberant tail signal 408 that is combined with early reflections to form a synthesized room impulse response.

The feedback delay network 400 is configured to model a late reverberation portion of a room impulse response without performing convolution with a long finite impulse response filter. Instead of explicitly representing thousands of coefficients corresponding to dense late reflections, the feedback delay network 400 generates a sum of decaying exponential components that perceptually approximate the reverberant tail of a physical space.

In the illustrated embodiment, the feedback delay network 400 includes a plurality of feedback loops, each feedback loop including a delay element 406 and a scaling coefficient β 404. Each delay element 406 provides a predetermined delay κ associated with a respective reverberation path. Each scaling coefficient β 404 controls a contribution of a corresponding delayed component to the overall reverberant tail signal 408.

A global feedback gain parameter α is applied within each feedback loop to control decay rate of the reverberation. The parameter α is constrained to a value less than one to ensure stability and exponential decay of energy over time. Together, the global decay parameter α, the scaling coefficients β 404, and the delay values κ associated with delay elements 406 define a set of decaying exponential components. The reverberant tail 408 is generated as a sum of these delayed and scaled exponential components.

In one embodiment, the feedback delay network 400 comprises sixteen feedback loops arranged in parallel. Each feedback loop produces a delayed exponential response, and the outputs of the feedback loops are summed to produce the reverberant tail 408. The structure may be viewed as a delayed sum of decaying exponentials, where each exponential corresponds to a modeled higher-order reflection within an environment.

The feedback delay network 400 is configured so that parameters α, β 404, and delay values κ of delay elements 406 are determined through differentiable optimization. The parameters are selected such that, when the reverberant tail 408 is combined with early reflections, the resulting synthesized room impulse response matches one or more acoustic or psychoacoustic metrics of a target room impulse response. In certain embodiments, the matched metrics include clarity, definition, center time, and decay time.

Because the reverberant tail 408 is generated using recursive feedback rather than direct convolution with a long impulse response, the feedback delay network 400 significantly reduces computational complexity. The structure enables sample-by-sample processing with a limited number of floating-point operations per input sample, thereby avoiding the high computational cost and latency associated with time-domain convolution or block-based Fourier transform processing.

Accordingly, the feedback delay network 400 provides an efficient and tunable mechanism for rendering late reverberation characteristics of a physical space while preserving perceptually relevant decay properties and maintaining low computational and memory requirements.

In aspects, the feedback delay network may be configured by selecting delay parameters and scale parameters according to a predetermined design rule that improves perceptual quality and computational efficiency. For example, a set of delay parameters may include values that are spaced on a logarithmic scale over a predefined time window so that the network includes both shorter delays that contribute to early portions of the reverberant tail and longer delays that contribute to later portions of the reverberant tail.

In aspects, the feedback delay network may be tuned using a differentiable objective that measures deviation between one or more target acoustic metric values and corresponding metric values computed from an output impulse response of the feedback delay network. For example, the system may compute at least one of clarity, definition, center time, and decay time from a target room impulse response and may compute corresponding metrics from a synthesized impulse response produced by the early reflection network combined with the feedback delay network. The system may then adjust at least one of a global decay parameter, per-loop scale parameters, or per-loop delay parameters to reduce the deviation between the target metrics and the synthesized metrics.

In aspects, the differentiable objective may include a weighted combination of metric residuals. For example, a loss function may include a first term corresponding to a residual for clarity, a second term corresponding to a residual for definition, a third term corresponding to a residual for center time, and a fourth term corresponding to a residual for decay time, and the system may assign different weights to the terms to prioritize perceptual attributes for a given application. In embodiments, the system may update the weights based on a user preference, a device mode, or a content type.

Regarding FIG. 5, a multipath propagation model 500 is shown. Multipath propagation model 500 converts FIR filters to equivalent IIR filters. The multipath propagation model 500 structures the resulting recursive filter as a cascade or parallel arrangement of biquadratic filters 502.

When an equivalent infinite impulse response (IIR) filter to a finite impulse response (FIR) filter is available, it is often preferred in applications where processing power is limited. This is because applying the IIR filter to a signal is computationally faster, more memory-compact, and results are usually obtained with lower latency compared to obtaining the output of the equivalent FIR filter. FIR filters are usually obtained as measured impulse responses of physical systems and are applied to the input signals as a convolution in time, or, for longer filters, in the frequency domain via application of the forward/inverse FFT. In contrast, IIR filters are recursive in nature, and the output at each time-step is immediately obtained as a weighted sum of the current input signal with outputs from previous steps.

Various streams of spatial audio rendering research have converged into the MPEG-H standard, which specifies mechanisms for rendering of up to 32 streams (a mixture of objects and ambisonics) with associated room metadata and head-tracking of the listener with respect to the source to create a dynamic spatial audio scene. Proprietary versions from various manufacturers incorporating these ideas have also been developed. Typically, spatial audio rendering involves convolving the streams corresponding to objects (and their early reflections off the environment) with Head Related Impulse Responses (HRIRs) that have been suitably chosen based on the user's relative motion with respect to the source via head-tracking. Such an operation comes at a significant cost in terms of computational time for convolving the generated filters and creating the tail reverberation. There is also a memory cost to storing the directional HRIR filters.

The motivation for pursuing the fitting of FIRs by IIRs was accommodating personalized head-related transfer functions (HRTFs) and multi-object spatial audio rendering on edge devices with SWAP (size, weight and power) constraints. Currently, this faces two issues. First, the inefficiency and cost of multiple FIR convolutions using rendering models such as the one in that have seen extensive use in VR and head-tracked headphone rendering. Second, efficient storage of the HRIRs on the edge device.

Converting FIR filters to equivalent IIR filters may be accomplished by estimating the coefficients of the Z-domain representation of the IIR filter through iterative solvers, neural networks, or even direct linear algebra under strict conditions. Given an FIR filter with q taps, and a desired order n IIR representation, these approaches seek to minimize a cost function based on a regularized mean square error (MSE) between the FIR and IIR filter in the Z-domain, where the FIR filter is a q-zero model and the IIR an n-pole-n-zero model. For q≥2n, an order n IIR filter puts 2n variables at disposal to achieve the desired optimal IIR. Structuring the resulting recursive filter as a cascade or parallel arrangement of biquadratic filters 502 has several benefits, including easy realization on DSP hardware.

The present disclosure relates to an approach for FIR-to-IIR fitting by estimating the coefficients of the time-domain representation of the IIR filter in a differentiable and usually convex manner. The present disclosure allows use of an arbitrary cost function. This flexibility is crucial, as different audio applications prioritize diverse criteria. It is observed that the structure of an FIR in audio applications often arises due to interaction of a propagating wave with surfaces. An intuition embedded in the approach is the ability to capture in the IIR the early multipath reflections in the FIR. As a result, high quality in the estimated channel response using lower-order IIR filters than previous works, is achieved. The present disclosure demonstrates results using the CIPIC HRIR database.

By adjusting the desired IIR filter order, a trade-off between accuracy and speedup over the FIR filter can be achieved. Furthermore, the present disclosure compares the results of the present disclosure against NIIRF, a recent work estimating HRIR with IIR filters. In the present disclosure, the filter model is restricted in two ways: first, to closely resemble a propagation model within an environment, and second, to be easily represented as biquad filters.

Other approaches for efficient HRIR implementation include approximating the corresponding FIR filter with a single or a set of smaller FIR filters, image based modelling and using spherical harmonic basis to project the source in an area-volumetric scene.

The present disclosure's approach uses application specific cost functions, and AD frameworks. This method is fully differentiable, allowing it to be easily utilized in higher-level optimization routines.

Biquad Filters are represented in the Z-domain as:

$$\frac{{b}_{0} + {b}_{1} {z}^{- 1} + {b}_{2} {z}^{- 2}}{1 + {a}_{1} {z}^{- 1} + a {z}^{- 2}} \qquad ( Eqn . 1 )$$

This expression with five coefficients can be rewritten as an expression with six coefficients (and thus not unique), provided the roots are monopole, as:

$$\frac{{c}_{0} + {c}_{1} {z}^{- 1}}{1 - {d}_{0} {z}^{- 1}} + \frac{{c}_{2} + {c}_{3} {z}^{- 1}}{1 - {d}_{1} {z}^{- 1}} \qquad ( Eqn . 2 )$$

The time-domain impulse response of Eqn. 2 corresponds to:

$${\sum }_{i = 0}^{1} {c}_{2 i} {d}_{i}^{n} u [ n ] + {c}_{2 i + 1} {d}_{i}^{n - 1} u [ n - 1 ] \qquad ( Eqn . 3 )$$

with u[n] being the Heaviside function at n. This allows the impulse response of a cascade of N biquad filters:

$${\sum }_{i = 0}^{2 N - 1} {c}_{2 i} {d}_{i}^{n} u [ n ] + {c}_{2 i + 1} {d}_{i}^{n - 1} u [ n - 1 ] \qquad ( Eqn . 4 )$$

to be written in the time-domain A goal of the present disclosure is to adjust the c and d coefficients so that the resulting IIR filter output matches that of the desired FIR filter. However, this model is still restrictive because the coefficients can only be adjusted up to first time shift, and the model requires reformulation to achieve compression.

By changing the model to:

$${\sum }_{i = 0}^{2 N - 1} {k}_{i} {α}_{i}^{n - 1} u [ n - i ] \qquad ( Eqn . 5 )$$

the present disclosure gains the ability to adjust the k and a coefficients of up to 2N−1-time shifts, enabling the design of an IIR filter of order up to 2N−1. In the Z-domain, this model is represented by

$${\sum }_{i = 0}^{2 N - 1} \frac{{k}_{i} {z}^{- i}}{1 - {α}_{i} {z}^{- 1}} \qquad ( Eqn . 6 )$$

which can be reshaped into a series of biquads with delays:

$${\sum }_{i = 0}^{N - 1} {z}^{- 2 i} \frac{{b}_{i 0} + {b}_{i 1} {z}^{- 1} + {b}_{i 2} {z}^{- 2}}{1 + {a}_{i 1} {z}^{- 1} + a i {z}^{- 2}} \qquad ( Eqn . 7 )$$

as can be seen in FIG. 5. The relationship between the coefficients in Eqn. 5 and Eqn. 7 can be obtained after some algebra as bᵢ₀=k₂ᵢ, bᵢ₁=k₂ᵢ₊₁−k₂ᵢα₂ᵢ₊₁, bᵢ₂=−k₂ᵢ₊₁α₂, aᵢ₁=−α₂ᵢ−α₂ᵢ₊₁, aᵢ₂=α₂ᵢα₂ᵢ₊₁.

A further simplification and extension are possible and allows the model to fit longer FIR filters. Going back to the time domain representation Eqn. 5, it is observed that it can be interpreted as a multipath propagation model, with coefficients kᵢ and aᵢ respectively corresponding to the reflection coefficients and path decay, for the signal received with a delay of i time-steps. Thus, the present disclosure estimates a propagation model that closely approximates a target FIR filter, and furthermore this model is realized as a collection of efficiently computed biquad filters. Real-world FIR filter responses such as HRIRs often adhere to a similar multipath propagation model.

Furthermore, since the path decay coefficient α in HRIRs is likely identical across all paths as the wave interaction with the head and ear tissue will be the same, the present disclosure has ∀ᵢαᵢ=α, reducing the number of variables. Specifically, to estimate an order 2N IIR filter using N biquad filters, only 2N+1 variables should be found instead of 4N−1. This significant reduction is useful for reducing the memory footprint in HRIR fitting, and in extending the reach of the IIR model to more taps in the FIR. This assumption is borne out by the experiments.

Solution via Automatic Differentiation: Given an input FIR, the present disclosure finds the coefficients kᵢ and α in:

$$\hat{h} [ n ] = {\sum }_{i = 0}^{2 N - 1} {k}_{i} {α}_{i}^{n - 1} u [ n - i ] \qquad ( Eqn . 8 )$$

by minimizing a suitably chosen cost function (“Cost”) measuring the difference in filter response. The present disclosure uses gradient-descent minimization of Cost. Evaluating the gradient is usually difficult, but using AD that is available via a tool such as JAX, provides immediate access to compiler computed exact derivatives, inbuilt parallel computing, and gradient descent to efficiently find the IIR filter as:

$$\hat{h} = {min}_{{k}_{i} , a , i = [ 0 , 2 N - 1 ]} Cost ( \hat{h} [ i ] , \hat{h} [ i ] ) \qquad ( Eqn . 9 )$$

where h is the impulse response of the target FIR filter. In an aspect of the present disclosure, the time domain impulse response mean squared error (MSE) as cost function is used, though further regularization and modifying the cost-function to capture perceptual behaviors are being explored. To improve computational efficiency, the present disclosure expresses the polynomial via Horner's rule to write Eqn. 8 as:

$$\hat{h} [ n ] = α ( {k}_{2 N - 1} u [ n - 2 N + 1 ] + α ( {k}_{2 N - 2} u [ n - 2 N + 2 ] + α ( … + α ( {k}_{1} u [ n - 1 ] {k}_{0} α u [ n ] ) ) ) ) \qquad ( Eqn . 10 )$$

reducing the cost for calculating ĥ[i] from O(N²) to O(N).

Listing 1, shows the MSE cost calculation, where s[i] refers to the target response, y[i] the estimated response, and k[i] and the coefficients kᵢ and α introduced in Eqn. 8.

Listing 1:

```
def loss_function(a,k):
  loss = 0
  for i in range(n):
    y[i] = 0
    if i<=k: y[i] = k[i]
y[i] += a*y[i−j−l]
loss += ({s[i] − y[i])**2}
return loss
```

While compiler constructed exact gradients are very useful, sometimes hand-created custom gradients are preferred, which may be more efficient, or incorporate custom modifications to take care of non-differentiable terms (e.g., to account for perceptual effects). The present disclosure implemented a code using JAX with the option of a custom gradient in C++.

The present disclosure aims to convert personalized HRIRs to IIRs. To test the algorithms of the present disclosure, the CIPIC dataset, a public-domain collection of high-spatial-resolution (1250 directions per ear) of 45 subjects, is used. Before being used as an estimation target, each HRIR is first normalized to unity gain and then trimmed to a l=160 length FIR filter starting from the direct path peak. The original gain and direct path delay values can be stored so that the original response can be recovered.

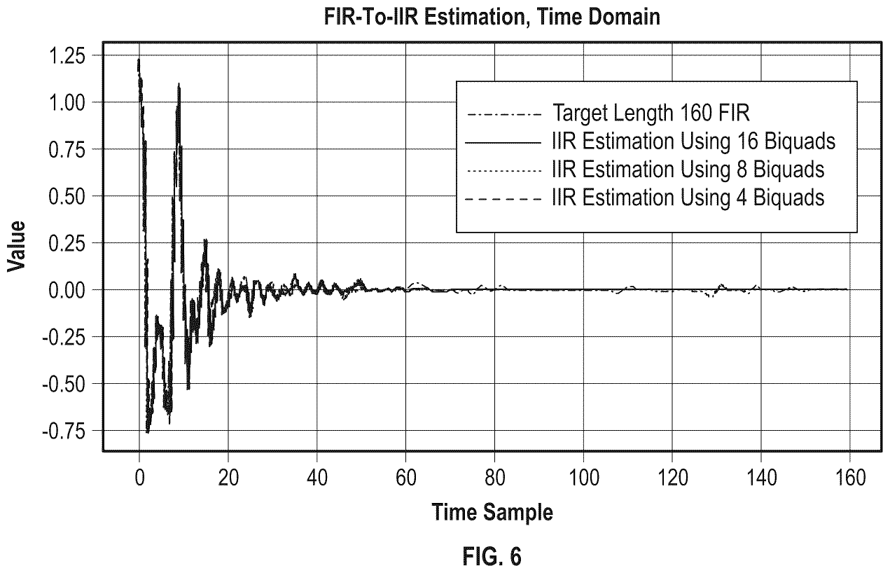

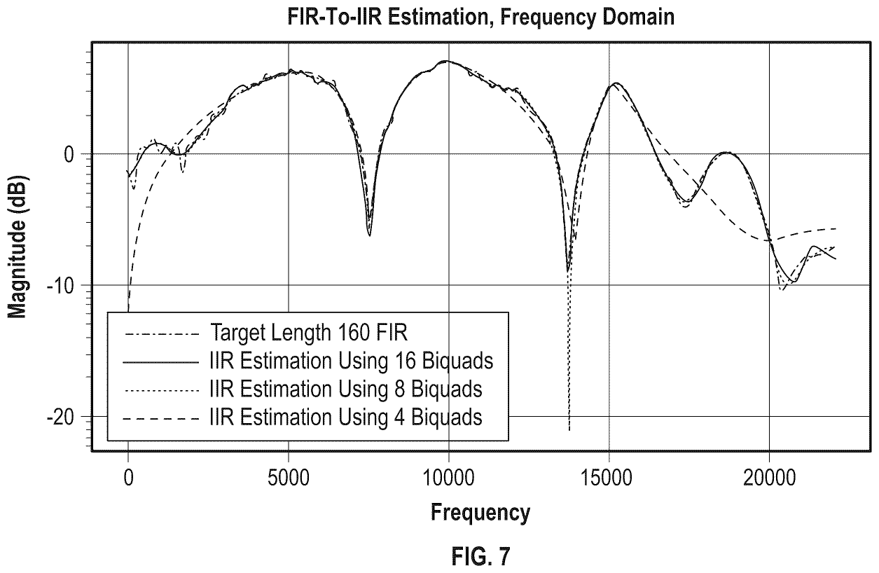

FIGS. 2(a) and 2(b) depict the impulse responses and frequency responses of an example length 160 HRTF FIR filter and the IIR filter estimations using 4, 8 and 16 biquad filters (order 8, 16 and 32 IIR filters). The present disclosure observed that not only is the FIR onset well-matched with the IIR estimation, but also the tail. For example, referring to FIG. 6, the order 31 IIR (16 biquads), not only the first 32-time samples match the FIR, but also up to the 60th time sample. This is due to the recursive nature of IIR filters. Moreover, as illustrated in FIG. 7, the frequency responses of the fitted filters preserve important spectral notch and peak features that are important for spatial audio perception even at lower orders.

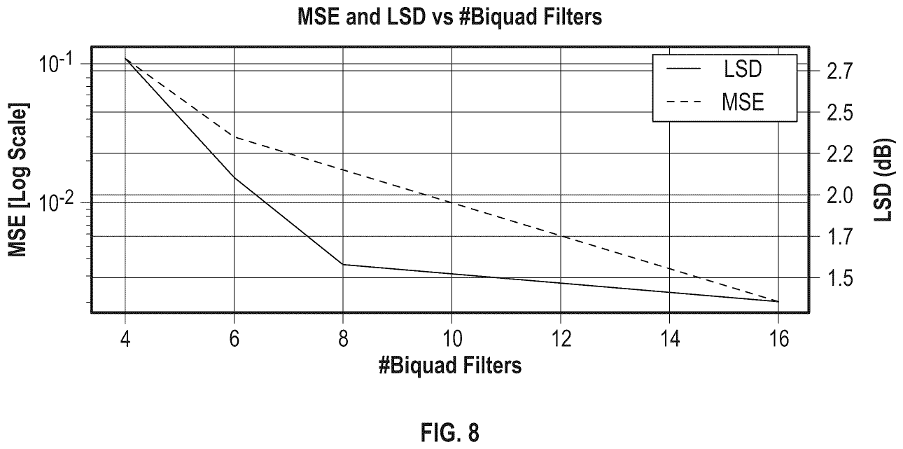

In an aspect, the present disclosure computed biquad approximations for every HRIR set in CIPIC via gradient-based optimization. FIG. 8 displays the impulse response MSE plotted against the number of biquad filters used, averaged over all locations and subjects provided by CIPIC.

Since time-domain HRIR MSEs may not align with auditory perception, the fitted IIR filter in the frequency domain is compared. To compare, a 256-point DFT is used to transform the target h and model ĥ HRIRs to frequency-domain HRTFs H and Ĥ, and compute the log-spectral distortion (LSD) as an additional validation metric. FIG. 8 shows the average LSD of the FIR-to-IIR estimation for all the CIPIC dataset, plotted against the number of biquads. A good approximation is illustrated.

In addition to approximation accuracy, the present disclosure analyzes both the theoretical and estimated performance improvement of the biquad configurations compared to the direct FIR filter implementation in Table I.

TABLE 1

| Filter | MSE | Speedup | Latency | Compr. |
|---|---|---|---|---|
| FIR | 0 | 1 | 160 | 1 |
| 4 Bi | 2.1(−1) | 11.4 | 8 | 17.8 |
| 8 Bi | 3.0(−2) | 5.7 | 16 | 9.4 |
| 16 Bi | 1.9(−3) | 2.86 | 32 | 4.8 |

The biquad filter implementation uses less memory. Theoretical memory footprints of the two methods can be computed as follows: the storage requirement for an FIR filter is its filter length l. For an N-filter biquad model, the 2N+1 coefficients describing the model must be stored. Note that in both cases, the present disclosure assumes the input is stored in a buffer of at least the size of the filter order and is thus a constant factor. Using N=16 biquad filters, requires 0.2 as much storage as the length 160 FIR filter while incurring 1.9×10⁻³ MSE and roughly 1.4 dB LSD, which is comparable to the 1 dB just-noticeable difference (JND) threshold between HRIRs for human subjects. Further, as biquad filter coefficients are less sensitive to quantization error, storing them with lower precision may lead to further memory savings. Modeling the relationship between coefficients and spatial position may provide further compression.

Next, the present disclosure estimates and compares runtimes of the two methods. First, the speed of the filter operations from CPU cycle benchmarks on a Cortex-M7 (STM32H747 processor compiled using Keil v5.06), without SIMD capabilities enabled, is derived. Table I presents the tradeoff between accuracy and speedup/latency/compression rate for FIR-to-IIR filter estimation. Specifically, the impulse response MSE using a different number of biquads is compared against the speedup provided over the target FIR implementation, latency, and storage compression rate. Using N=16 biquad filters, a speedup of 2.86× for a length 160 FIR was achieved.

Moreover, the solution time for the IIR estimation itself is only 4.12 ms using the custom C++ gradient descent on an Intel® core i7-10750H CPU and 2.60 GHz processor.

With GPU acceleration, the present disclosure is able to fit the entirety of the CIPIC database consisting of 45 subjects left and right HRIRs at 1250 different locations in 5 minutes. While training costs are usually not important in database fitting, this fast execution enables real-time or online implementation, or incorporation in a deep learning network.

In an aspect, the present disclosure is compared against NIIRF, a recent neural network-based approach that approximates the HRIR with an IIR filter, where the filter coefficients are learnt in frequency domain using the neural network. Table II shows the results in terms of LSD and speedup using the CIPIC dataset under the same hardware settings described above.

TABLE 2

| IIR Filter | Number of | The Present Disclosure | | NIIRF | |
|---|---|---|---|---|---|
| Order | Biquads | LSD | Speedup | LSD | Speedup |
| 8 | 4 | 2.8 | 11.4 | 3.9 | 11.4 |
| 32 | 16 | 1.2 | 2.9 | 3.6 | 2.9 |

There are two takeaways from this comparison. First, in NIIRF, when the filter order is increased from 8 to 32, the LSD decreases only slightly. This implies that the frequency-domain modeling results in a highly non-convex optimization problem. This is to be expected since the IIR filter coefficients appear in both the numerator and denominator terms of the transfer function (see Eq. 7). Second, in contrast, the approach of the present disclosure exhibits a significant decrease in LSD as the filter order increases, and the LSD achieved is substantially lower than that of NIIRF. This implies that the model of the present disclosure formulates a well-defined optimization problem that aligns better with the underlying physics of the HRIR approximation. This is to be expected since the optimization of the present disclosure is convex and formulated based on a multi-path propagation model, which captures the characteristics of the problem.

Using the SS2 dataset, the present disclosure extracted HRIRs spanning a range of azimuths (−180≤φ≤180) and elevations (−80≤θ≤80), totaling 14,400 HRIRs. The algorithm was then employed to learn the corresponding IIR coefficients for a user in the database. Then the design of the present disclosure was implemented using AUDIOWEAVER, where the IIR filter coefficients change based on φ and θ in real time. The user was able to localize the sound source without compromising sound quality.

Using a formulation of FIR-to-IIR estimation, and differentiable programming, the present disclosure illustrates a fast and efficient procedure to design a set of IIR filters that fit a target FIR response with low error in time and frequency-domains. Some avenues of future work include exploring more specialized cost functions (e.g., perceptual metrics, frequency-time domain hybrid objectives), using different figures of merit for contralateral and ipsilateral HRIRs, as well as model-based fitting of filter coefficients with azimuth, elevation, and ear anthropometry for further compression.

Although spatial audio is used as example, other uses are contemplated to be within this disclosure, such as headsets that use convolution and IRs, processing for underwater modems (e.g., correcting for delays in various frequencies), and/or Bluetooth® speakers and trans-aural rendering, or anywhere an IIR may be used to correct for a delay.

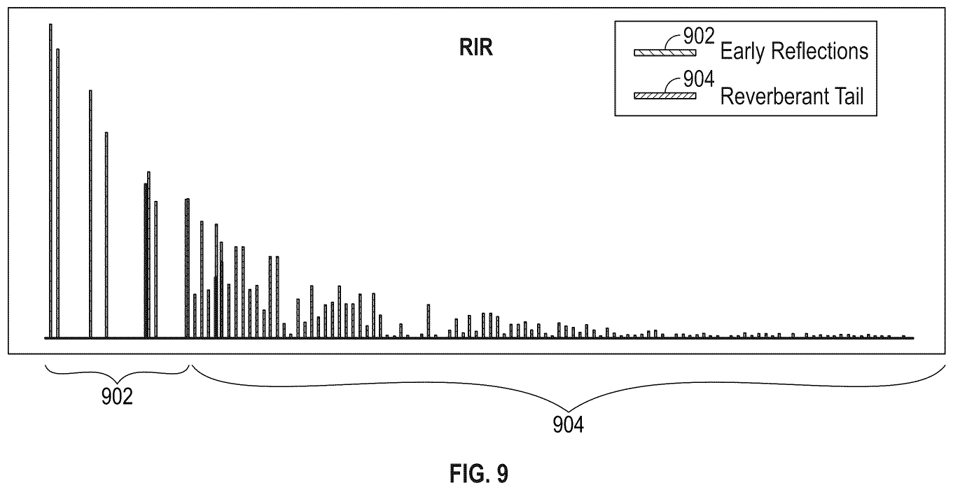

FIG. 9 is a graphical illustration of a synthesized room impulse response generated by the system of FIG. 1, showing both early reflections 902 and a reverberant tail 904. The graph presents magnitude as a function of time, visually distinguishing sparse early reflections from a dense, decaying late reverberation region. Note, some areas of early reflection and reverberant tail may overlap.

An initial set of discrete peaks corresponds to early reflections produced by the early reflection network. These early reflections appear as distinct, high-amplitude impulses separated in time. Each peak represents a direct path or a low-order reflection from environmental surfaces, such as walls, floor, or ceiling. The temporal spacing of the peaks reflects path delays associated with different propagation paths, and the amplitudes correspond to path gains derived from a target room impulse response. Because early reflections are perceptually significant for spatial localization, the peaks are clearly defined and individually distinguishable in the time-domain plot.

Following the early reflection region, a densely populated region of lower-amplitude energy corresponds to the reverberant tail generated by the feedback delay network. Unlike the early reflections, the reverberant tail does not consist of isolated impulses. Instead, the reverberant tail forms a continuous, exponentially decaying envelope. The energy gradually decreases over time according to a decay rate determined by feedback parameters of the feedback delay network.

The transition between the early reflection region and the reverberant tail region may be visible as a shift from sparse, high-magnitude impulses to a smoother, noise-like decay pattern. Although individual reflections in the reverberant tail are not perceptually resolved, the overall decay profile reflects acoustic characteristics of a modeled space, such as clarity, definition, center time, and decay time.

The illustrated impulse response demonstrates that the synthesized room impulse response preserves perceptually important early reflection timing and amplitude while efficiently approximating late reverberation using a feedback delay network. The combined output replicates the structure of a physical room impulse response without requiring convolution with a long finite impulse response filter.

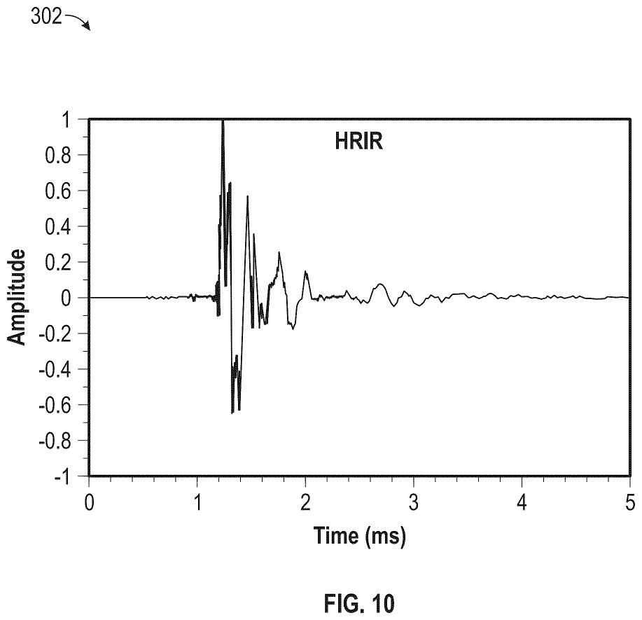

FIG. 10 is a graphical illustration of the head-related impulse response 302 plotted as magnitude versus time. The graph represents a time-domain impulse response corresponding to acoustic scattering effects of a listener's head, torso, and outer ear for a particular source direction.

The horizontal axis represents time samples, and the vertical axis represents amplitude or magnitude of the impulse response. An initial prominent peak corresponds to the direct acoustic arrival at the ear. Subsequent smaller oscillatory components represent reflections and diffractions caused by anatomical structures. These secondary components occur shortly after the direct path and contribute to direction-dependent spectral shaping that enables spatial localization.

The impulse response typically exhibits a short duration relative to a full room impulse response and may include multiple fine-scale fluctuations that encode elevation and azimuth cues. The waveform may decay rapidly after the primary peak, reflecting limited reverberant contribution from the body itself.

The illustrated head-related impulse response 302 serves as an input to the early reflection network and the feedback delay network within the spatial audio rendering system. In certain embodiments, the head-related impulse response 302 may be represented as a finite impulse response filter prior to conversion into an infinite impulse response representation for efficient processing.

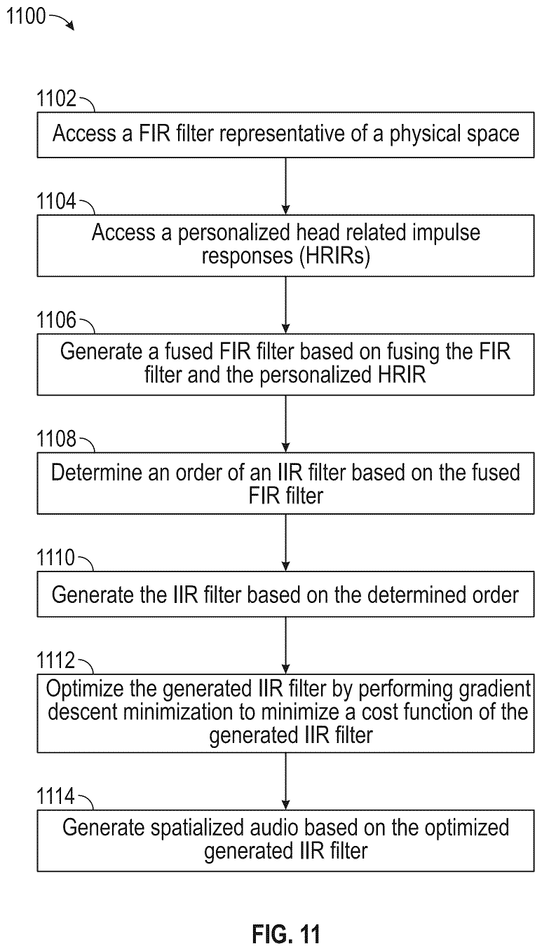

FIG. 11 shows a block diagram for an exemplary method for converting a finite impulse response filter to an infinite impulse response filter for efficient spatial audio rendering. Although the steps of FIG. 11 are shown in a particular order, the steps need not all be performed in the specified order, and certain steps can be performed in another order. For example, FIG. 11 is described with a processor performing the operations. However, in various aspects, the operations of FIG. 11 may be performed all or in part by the user device 200 of FIG. 1. In certain aspects, the operations of FIG. 11 may be performed all or in part by another device, such as a mobile device, a headset, a digital signal processor, or a user computer system.

At operation 1102, the processor causes the system to access a finite impulse response filter representative of a physical space. The finite impulse response filter may correspond to a room impulse response that models the propagation of sound within an environment, including direct sound and reflections from surfaces. The finite impulse response filter may be stored in memory, retrieved from a database, received from a remote server, or generated through acoustic measurement or simulation.

In one embodiment, the finite impulse response filter is obtained by measuring an impulse response within a room using a calibrated microphone and an excitation signal such as a swept sine wave. The measured response is processed to produce a discrete-time impulse response of length (samples. In another embodiment, the finite impulse response filter is generated using a geometric acoustics simulation based on room dimensions, surface materials, and source and listener positions.

The processor may normalize the finite impulse response filter, trim the filter to a selected duration, or align the filter relative to a detected direct path peak prior to further processing. The finite impulse response filter accessed at operation 1102 serves as a target response that will later be approximated by an infinite impulse response filter in order to reduce computational cost, memory usage, and processing latency during spatial audio rendering.

By accessing a finite impulse response filter representative of a physical space, the system establishes a physically meaningful reference that captures acoustic characteristics of the environment, which are subsequently incorporated into an efficient infinite impulse response representation.

At operation 1104, the processor causes the system to access personalized Head Related Impulse Responses (HRIRs). The personalized HRIRs represent direction-dependent acoustic transformations caused by interaction of sound waves with anatomical features of a listener, including the head, torso, and outer ear. Each Head Related Impulse Response corresponds to a particular spatial direction relative to the listener.

The personalized HRIRs may be stored locally on a user device, retrieved from a database, generated from a parametric anthropometric model, or estimated from measurements performed for a specific user. In one embodiment, the Head Related Impulse Responses are selected from a precomputed dataset indexed by azimuth and elevation angles. In another embodiment, the Head Related Impulse Responses are derived from a personalized fitting procedure based on user-specific ear and head geometry.

The processor may select one or more HRIRs corresponding to current source positions and listener head orientation, as determined by head-tracking data. For example, when a sound source is located at a particular azimuth and elevation relative to the listener, the system retrieves the corresponding left-ear and right-ear Head Related Impulse Responses for that direction.

The accessed personalized HRIRs serve as directional filters that encode spatial localization cues. These responses are subsequently combined with the finite impulse response filter representative of the physical space to form a fused finite impulse response filter that captures both environmental propagation effects and body-based scattering effects.

At operation 1106, the processor causes the system to generate a fused finite impulse response filter based on fusing the finite impulse response filter representative of the physical space and the personalized HRIRs. The fused finite impulse response filter represents a combined acoustic response that incorporates both environmental propagation effects and listener-specific anatomical filtering effects.

In one embodiment, generating the fused finite impulse response filter includes convolving the finite impulse response filter representative of the physical space with a selected HRIR corresponding to a particular source direction. The convolution operation produces a composite impulse response that models how a sound emitted in the physical space is modified first by reflections within the environment and subsequently by scattering from the listener's head and ears.

In another embodiment, the fusion operation includes separately applying the HRIR to individual components of the room impulse response, such as a direct path and early reflections, and then combining the filtered components to form the fused finite impulse response filter. The fused finite impulse response filter may be represented as a discrete-time sequence of samples capturing both directional and environmental characteristics.

The processor may normalize or align the fused finite impulse response filter to preserve overall gain and timing characteristics. For example, the processor may align the fused response based on a detected direct-path peak and maintain stored gain values to ensure accurate reconstruction during rendering.

The fused finite impulse response filter generated at operation 1106 serves as a target response that is subsequently approximated by an infinite impulse response filter. By incorporating both room and personalized directional effects into a single fused representation, the system ensures that subsequent infinite impulse response estimation preserves perceptually important spatial cues while reducing computational complexity.

At operation 1108, the processor causes the system to determine an order of an infinite impulse response filter based on the fused finite impulse response filter. The order of the infinite impulse response filter corresponds to a number of poles and zeros, or equivalently, a number of biquadratic sections used to approximate the fused finite impulse response filter.

Determining the order may include selecting a number of biquadratic filters arranged in cascade or parallel form to achieve a desired trade-off between approximation accuracy and computational efficiency. In one embodiment, the processor selects an order corresponding to 4, 8, or 16 biquadratic filters. A higher number of biquadratic filters generally enables closer approximation of the fused finite impulse response filter, while a lower number reduces memory usage and processing latency.

The processor may determine the order based on one or more criteria, including a target mean squared error threshold, a log-spectral distortion threshold, available processing resources, memory constraints, or a latency budget associated with a target device. For example, when operating on a resource-constrained wearable device, the processor may select a lower order infinite impulse response filter to reduce computational load. When higher fidelity is required and sufficient processing resources are available, the processor may select a higher order.

In certain embodiments, determining the order includes analyzing characteristics of the fused finite impulse response filter, such as its effective duration, energy distribution, or spectral complexity. The processor may estimate a minimum order required to achieve an acceptable approximation based on these characteristics.

The determined order establishes a structural configuration for the infinite impulse response filter that will be generated in a subsequent operation. By adaptively selecting the order based on the fused finite impulse response filter and system constraints, the method enables efficient spatial audio rendering while maintaining perceptual quality.

At operation 1110, the processor causes the system to generate the infinite impulse response filter based on the determined order. The infinite impulse response filter is structured according to the selected number of poles and zeros, which may be implemented as a cascade or parallel arrangement of biquadratic filter sections.

Generating the infinite impulse response filter includes initializing filter coefficients corresponding to numerator and denominator terms of each biquadratic section. In one embodiment, the filter is represented in a time-domain multipath propagation form, where the impulse response is modeled as a sum of delayed, exponentially decaying components. In this representation, a set of scaling coefficients and at least one decay parameter are defined consistent with the selected order.

In another embodiment, the processor generates the infinite impulse response filter in the Z-domain and then maps the representation into biquadratic sections suitable for digital signal processing hardware. The mapping may include determining coefficients for each biquadratic section such that the overall filter structure corresponds to the desired order.

The processor may initialize the coefficients using predefined values, random initialization, heuristic estimation based on the fused finite impulse response filter, or values derived from analytical approximation. These initialized coefficients serve as starting points for subsequent optimization.

The generated infinite impulse response filter at this stage represents a candidate recursive filter structure that approximates the fused finite impulse response filter. The coefficients are subsequently refined during optimization to minimize a cost function that measures deviation between the fused finite impulse response filter and the infinite impulse response approximation.

At operation 1112, the processor causes the system to optimize the generated infinite impulse response filter by performing gradient descent minimization to minimize a cost function of the generated infinite impulse response filter. The optimization adjusts one or more filter coefficients so that a response of the infinite impulse response filter closely approximates a response of the fused finite impulse response filter.

The cost function may measure a difference between the impulse response of the fused finite impulse response filter and the impulse response produced by the generated infinite impulse response filter. In one embodiment, the cost function is a time-domain mean squared error computed over a selected number of samples. In another embodiment, the cost function includes a frequency-domain metric such as log-spectral distortion. In further embodiments, the cost function may include regularization terms or perceptual weighting to emphasize perceptually significant portions of the response.

The processor computes gradients of the cost function with respect to the infinite impulse response filter coefficients. In one embodiment, automatic differentiation is used to compute exact gradients of the cost function with respect to scaling coefficients and decay parameters. In another embodiment, custom gradient expressions are implemented to improve computational efficiency or incorporate application-specific constraints.

Using the computed gradients, the processor iteratively updates the filter coefficients according to a gradient descent procedure. The update may include applying a learning rate parameter and may continue until a convergence criterion is satisfied, such as reaching a threshold error value or completing a predetermined number of iterations.

For example, given a fused finite impulse response filter of length 160 samples, the processor may initialize an infinite impulse response filter having 16 biquadratic sections and iteratively update coefficients to reduce mean squared error between the two impulse responses. After convergence, the optimized infinite impulse response filter achieves a low approximation error while requiring substantially fewer stored coefficients and reduced computational cost during runtime filtering.

The optimized infinite impulse response filter produced at operation 1112 is subsequently used to generate spatialized audio with reduced memory usage and lower latency compared to direct convolution with the fused finite impulse response filter.

At operation 1114, the processor causes the system to generate spatialized audio based on the optimized generated infinite impulse response filter. Generating spatialized audio includes filtering an input audio signal using the optimized infinite impulse response filter to produce an output signal that incorporates environmental propagation effects and personalized directional cues.

In one embodiment, the processor applies the optimized infinite impulse response filter to one or more audio streams corresponding to virtual sound sources. The filtering operation is performed recursively, such that each output sample is computed as a function of a current input sample and one or more prior output samples according to coefficients of the optimized infinite impulse response filter. Because the filter is recursive and implemented as a cascade or parallel arrangement of biquadratic sections, the computation requires fewer operations and less memory than direct convolution with a long finite impulse response filter.

The processor may generate separate spatialized audio signals for a left ear and a right ear by applying corresponding optimized infinite impulse response filters derived from direction-specific Head Related Impulse Responses. Head-tracking information may be used to dynamically select or update filter coefficients corresponding to a current source direction and listener orientation.

For example, when a virtual sound source is positioned at a particular azimuth and elevation relative to a listener wearing headphones, the processor retrieves or computes an optimized infinite impulse response filter corresponding to that direction and applies the filter to the audio stream in real time. As the listener turns the head, updated infinite impulse response filter coefficients may be selected or recomputed, enabling continuous spatial rendering without introducing substantial latency.

The spatialized audio generated at operation 1114 may be output to headphones, smart glasses, mobile devices, speakers, or other audio playback systems. By using the optimized infinite impulse response filter rather than a long finite impulse response convolution, the system achieves reduced computational load, lower memory footprint, and decreased processing latency while maintaining perceptual fidelity of spatial cues.

At operation 1116, the processor causes the system to update one or more parameters of the infinite impulse response filter in response to a change in at least one of source position, listener orientation, room metadata, or device constraints. Operation 1116 enables dynamic spatial audio rendering in real time without requiring recomputation of a full finite impulse response convolution.

In one embodiment, head-tracking data is received from a sensor associated with a headset or mobile device. Based on updated azimuth and elevation values, the processor selects a corresponding set of personalized HRIRs and repeats one or more of operations 1106 through 1112 to generate updated infinite impulse response filter coefficients. In another embodiment, precomputed infinite impulse response filters corresponding to discrete spatial directions are stored in memory, and the processor selects an appropriate filter or interpolates between adjacent filters to maintain smooth spatial transitions.

In certain aspects, operation 1116 includes adjusting an order of the infinite impulse response filter based on available processing resources or a selected quality mode. For example, when operating in a power-saving mode, the processor may reduce a number of biquadratic sections to lower computational cost. When higher fidelity is required, the processor may increase the number of sections and re-optimize coefficients to achieve improved approximation accuracy.

In further embodiments, operation 1116 includes updating decay parameters or scaling coefficients associated with environmental modeling when room characteristics change. For example, when a user transitions from a small room to a larger hall in a virtual environment, the processor may modify decay-related parameters to reflect a longer reverberation time while preserving spatial localization cues.

By dynamically updating filter parameters rather than performing full convolution with long impulse responses, operation 1116 maintains low latency and efficient resource usage while preserving perceptual continuity in the spatial audio experience.

In aspects, optimizing the infinite impulse response filter may include selecting an optimization procedure that uses automatic differentiation to compute gradients of a cost function with respect to coefficients of the infinite impulse response filter. The cost function may include a time-domain error term, a frequency-domain error term, or a combined error term. For example, the cost function may include a weighted sum of (i) a time-domain mean squared error computed between a target impulse response and an estimated impulse response, and (ii) a frequency-domain log-spectral distortion term computed between a target transfer function magnitude response and an estimated transfer function magnitude response.

In aspects, the optimization procedure may include applying one or more constraints to ensure filter stability and to prevent coefficient values from diverging. For example, decay-related parameters may be re-parameterized using a bounded function so that the decay remains in a stable range, and a penalty term may be added to the cost function when any stability constraint is violated. In embodiments, the optimization procedure may terminate when at least one of a maximum iteration count is reached, an improvement in the cost function falls below a threshold, or an approximation error satisfies a target threshold.

In aspects, determining an order of the infinite impulse response filter may include evaluating multiple candidate orders and selecting an order based on a tradeoff between approximation accuracy and computational cost. For example, the system may generate candidate filters using 4, 8, and 16 biquadratic sections, compute an error metric for each candidate, and select a candidate that meets an error threshold while minimizing a number of operations per sample. In embodiments, the selected order may be stored along with coefficients to permit rapid retrieval and use during runtime rendering.

In aspects, the system may include a room impulse response decomposition stage that separates a room impulse response into an early reflection component and a reverberant tail component prior to rendering. The early reflection component may include discrete, sparse reflections corresponding to a direct path and low-order reflections from environmental boundaries. The reverberant tail component may include dense, higher-order reflections that form a decaying energy envelope. The processor may perform the decomposition based on time-domain energy thresholds, peak detection within an initial time window, or metadata describing a physical or virtual environment.

In aspects, the early reflection component may be rendered with direction-dependent filtering such that each early reflection path is associated with a corresponding spatial direction and a corresponding personalized HRIR. The processor may apply the finite impulse response to infinite impulse response conversion method described above to each direction-specific HRIR associated with a direct path or early reflection path. Each reflection path may then be delayed according to a path delay parameter and scaled according to a path gain parameter to preserve perceptually important timing and amplitude cues for spatial localization.

In aspects, the reverberant tail component may be generated using a differentiable feedback delay network having a plurality of feedback loops. Each feedback loop may include a delay parameter and a scaling parameter, and the feedback delay network may include a global decay parameter constrained to ensure stability. The parameters of the feedback delay network may be selected so that an energy decay profile of the generated reverberant tail matches perceptually relevant acoustic metrics of a target room impulse response.

In aspects, the acoustic metrics used to configure the reverberant tail may include clarity, definition, center time, and reverberation decay time. The processor may determine parameters of the feedback delay network by minimizing a loss function that measures deviation between one or more target metric values and corresponding metric values computed from the generated reverberant tail. The loss function may include a weighted combination of metric residuals, and gradient-based optimization may be used to determine parameter values.

In aspects, the early reflection component and the reverberant tail component may be combined to form a synthesized room impulse response that is applied to one or more audio streams on a sample-by-sample basis without block-based Fourier processing. The combined rendering may preserve perceptually important spatial localization cues through accurate early reflection timing while approximating late reverberation through metric-matched decay behavior.

In aspects, one or more parameters associated with the early reflection component and the reverberant tail component may be updated in real time in response to listener movement, source movement, or a change in room metadata. Head-tracking data may be used to select updated direction-specific infinite impulse response filters for early reflections, and feedback delay network parameters may be adjusted to reflect changes in room size, absorption characteristics, or other environmental attributes. This architecture may enable continuous spatial rendering with reduced computational complexity and reduced latency relative to convolution-based approaches.

In aspects, the system may implement an integrated spatial audio rendering pipeline in which a room impulse response is decomposed into an early reflection component and a reverberant tail component, and the two components are rendered using different computational mechanisms that are selected based on perceptual sensitivity and resource constraints. For example, the early reflection component may be rendered using a sparse path-based model that preserves reflection timing and amplitude, while the reverberant tail component may be rendered using a recursive feedback delay network that is configured to match one or more acoustic metrics of a target room response.

In aspects, the early reflection component may be generated by identifying a set of discrete reflection events within a predetermined early time window of a target room impulse response. The set of reflection events may be identified using peak detection, thresholding of a short-time energy envelope, or selection of the largest-magnitude peaks within the early time window. Each identified event may be assigned a path delay value and a path gain value, and the system may generate an early reflection output by applying the path gain and the path delay to a direction-dependent head-related impulse response and summing the resulting delayed contributions.

In aspects, the reverberant tail component may be generated without directly convolving an input audio signal with a long finite impulse response tail. Instead, the system may configure a feedback delay network to generate a decaying response whose aggregate behavior matches perceptually relevant characteristics of the target room. For example, the system may tune a global decay parameter, a set of per-loop scaling parameters, and a set of per-loop delay parameters so that the reverberant tail produced by the feedback delay network yields target values for one or more acoustic metrics, while maintaining stability by constraining the global decay parameter to be less than one.

In aspects, the system may generate a synthesized room impulse response by combining the early reflection output and the reverberant tail output, and may apply the synthesized response to one or more audio streams on a sample-by-sample basis using recursive filtering and delay-line operations, thereby avoiding block-based Fourier processing and reducing latency. In embodiments, the early reflection portion may be rendered with a first computational budget, the reverberant tail may be rendered with a second computational budget, and the budgets may be adjusted dynamically based on device constraints.

In aspects, the system may support head-tracked spatial audio by updating one or more direction-dependent filters in response to a change in at least one of listener orientation or source position. For example, the system may select a different head-related impulse response corresponding to an updated direction or may select a different infinite impulse response representation corresponding to that direction, while maintaining continuity through interpolation between nearby directions. In embodiments, the system may update early reflection direction-dependent filtering at a first update rate and may update feedback delay network parameters at a second, lower update rate to reduce computational overhead.

In aspects, the system may enforce stability during infinite impulse response generation and optimization by constraining pole-related parameters, decay parameters, or equivalent coefficients to remain within a predetermined stable region. For example, when an infinite impulse response filter is expressed using decay parameters α_i, the system may constrain each α_i to be less than one in magnitude and may optionally apply a penalty term in a loss function when any stability constraint is violated.

In aspects, the system may determine an order of an infinite impulse response representation using a resource-aware selection process. For example, the system may select a smallest number of biquadratic sections that satisfies a target approximation error threshold, such as a target mean squared error threshold or a target log-spectral distortion threshold, while also satisfying a latency budget associated with an edge device. In embodiments, the system may increase the number of biquadratic sections when a high-quality mode is enabled and may decrease the number of biquadratic sections when a power-saving mode is enabled.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for converting from a finite impulse response (FIR) filter to an infinite impulse response (IIR) filter, comprising:
a processor; and
a memory, including instructions stored thereon, which when executed by the processor cause the system to:
access a FIR filter representative of a physical space;
access a personalized Head Related Impulse Responses (HRIRs);
generate a fused FIR filter based on fusing the FIR filter and the personalized HRIR;
determine an order of an IIR filter based on the fused FIR filter;
generate the IIR filter based on the determined order;
optimize the generated IIR filter by performing gradient descent minimization to minimize a cost function of the generated IIR filter; and
generate spatialized audio based on the optimized generated IIR filter.

2. The system of claim 1, wherein determining the order of the IIR filter is performed by estimating coefficients of a time-domain representation of the IIR filter in a differentiable and convex manner.

3. The system of claim 1, wherein the order of the IIR filter corresponds to at least one of: a cascade or a parallel arrangement of 4, 8, or 16 biquadratic filters.

4. The system of claim 3, wherein the instructions, when executed by the processor, further cause the system to:
dynamically change a quality of the audio based on changing a quantity of biquadratic filters.

5. The system of claim 1, wherein the cost function is a time domain impulse response mean squared error (MSE).

6. A processor-implemented method for converting from a finite impulse response (FIR) filter to an infinite impulse response (IIR) filter, comprising:
accessing a FIR filter representative of a physical space;
accessing a personalized Head Related Impulse Responses (HRIRs);
generating a fused FIR filter based on fusing the FIR filter and the personalized HRIR;
determining an order of an IIR filter based on the fused FIR filter;
generating the IIR filter based on the determined order;
optimizing the generated IIR filter by performing gradient descent minimization to minimize a cost function of the generated IIR filter; and
generating spatialized audio based on the optimized generated IIR filter.

7. A system for efficiently spatializing audio, comprising:
a processor; and
a memory, including instructions stored thereon, which when executed by the processor cause the system to:
generate a room impulse response composed of a set of early reflections;
approximate a reverberant tail using a differentiable feedback delay network; and
generate spatialized audio based on the generated set of early reflections and the generated reverberant tail.

8. The system of claim 7, wherein the set of early reflections are generated by converting from a finite impulse response (FIR) filter to an infinite impulse response (IIR) filter, which comprises:
accessing a FIR filter representative of a physical space;
accessing a personalized Head Related Impulse Responses (HRIRs);
generating a fused FIR filter based on fusing the FIR filter and the personalized HRIR;
determining an order of an IIR filter based on the fused FIR filter;
generating the IIR filter based on the determined order; and
optimizing the generated IIR filter by performing gradient descent minimization to minimize a cost function of the generated IIR filter.

9. The system of claim 7, wherein the differentiable feedback delay network comprises a plurality of feedback loops, each feedback loop including a delay element and a feedback gain configured to generate a decaying exponential component of the reverberant tail.

10. The system of claim 7, wherein the differentiable feedback delay network comprises sixteen feedback loops arranged in parallel.

11. The system of claim 7, wherein the differentiable feedback delay network includes a global decay parameter and a plurality of scale parameters and delay parameters, and wherein the global decay parameter is constrained to a value less than one to ensure stability.

12. The system of claim 7, wherein the differentiable feedback delay network is configured such that delay parameters are selected on a logarithmic spacing within a predefined time window corresponding to early reflection duration.

13. The system of claim 7, wherein the differentiable feedback delay network is optimized to match at least one acoustic or psychoacoustic metric selected from the group consisting of clarity, definition, center time, and reverberation decay time.

14. The system of claim 7, wherein the differentiable feedback delay network includes differentiable feedback delay network parameters that are determined by minimizing a loss function comprising a weighted combination of acoustic metric residuals.

15. The system of claim 7, wherein the generated set of early reflections and the generated reverberant tail are mixed to form a synthesized room impulse response applied to an input audio stream on a sample-by-sample basis without block-based Fourier processing.

16. The system of claim 7, wherein the differentiable feedback delay network is configured to update one or more parameters in real time in response to at least one of listener movement, source movement, or a change in room metadata.

17. The system of claim 8, wherein the optimized generated IIR filter is implemented as a cascade or parallel arrangement of biquadratic filters.

18. The system of claim 8, wherein converting from the FIR filter to the IIR filter comprises estimating coefficients of a time-domain multipath propagation model having a plurality of reflection coefficients and a shared decay coefficient.

19. The system of claim 8, wherein the fused FIR filter represents early reflections of a room impulse response and the differentiable feedback delay network represents a reverberant tail of the room impulse response.

20. The system of claim 8, wherein the cost function minimized during gradient descent comprises a time-domain mean squared error between an impulse response of the fused FIR filter and an impulse response of the generated IIR filter.
